(19) United States
(12) Patent Application Publication
(10) Pub. No.: US 2004/0183538 A1
(43) Pub. Date: Sep. 23, 2004

(54) Structure for electromagnetic induction well logging apparatus

(76) Inventors: Tilman Hanstein, Houston, TX (US); Horst Rueter, Houston, TX (US); Kurt M. Strack, Houston, TX (US)

Correspondence Address: Richard A. Fagin, P O Box 1247, Richmond, TX, 77406-1247, US

(21) Appl. No.: 10/392,298

(22) Filed: Mar. 19, 2003

(51) Int. Cl. G01V 3/18; E21B 47/02

(52) U.S. Cl. 324/339; 175/45

(57) ABSTRACT

An electromagnetic induction logging instrument is disclosed, which includes an electrically conductive support. At least one magnetic dipole transmitter antenna is disposed on the support. At least one magnetic dipole receiver antenna is disposed on the support and is axially spaced apart from the position of the transmitter antenna. The instrument includes a magnetically permeable shield disposed between the support and the transmitter and receiver. The shield extends substantially the distance between the transmitter and receiver. A measurement while drilling instrument is also disclosed, including an electrically conductive collar, at least one transmitter antenna disposed at a selected position on the collar and at least one receiver antenna disposed on the collar axially spaced apart from the transmitter antenna. A magnetically permeable shield is disposed between the collar, and the transmitter and receiver, and extends substantially the distance between the transmitter and receiver.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of electromagnetic induction well logging. More specifically, the invention relates to structures for electromagnetic induction well logging instruments having a conductive instrument housing.

2. Background Art

Electromagnetic induction well logging is known in the art for determining electrical properties of earth formations penetrated by a wellbore, such as resistivity, dipole constant, and various nuclear magnetic resonance properties, for example. In electromagnetic induction logging, an instrument is lowered into the wellbore. The instrument includes an induction antenna (“transmitter antenna”) coupled to a source of alternating current (AC) having a preselected waveform or a dynamically controllable waveform. Characteristics of the AC waveform, for example, frequency content and amplitude envelope, are selected with respect to the particular properties of the Earth's formations that are being measured. The instrument also includes one or more induction antennas (“receiver antenna(s)”) disposed at axially spaced apart positions along the instrument from the transmitter antenna. Some instruments, particularly nuclear magnetic resonance instruments, may use the same antenna for both transmitter and receiver functions. The receiver antenna(s) are coupled to circuits which analyze and/or record properties of voltages induced in the receiver antenna(s). Properties of the voltages are analyzed to determine the selected electrical characteristics of the Earth's formations surrounding the instrument. The analyzed properties of the voltages include, for example, amplitude, frequency content and phase with respect to the AC coupled to the transmitter antenna.

A common type of induction antenna, used for both transmitter and receiver functions on a typical induction well logging instrument is a so-called magnetic dipole. Magnetic dipole antennas are typically formed as a wire loop or coil. The magnetic dipole moment of the loop or coil is oriented substantially perpendicular to the plane of the loop, or in the case of a coil, substantially parallel to the effective axis of the coil. The loops or coils are typically disposed in appropriate locations near the exterior surface of the instrument housing. As a result of the structure of the typical magnetic dipole antenna, the material from which the instrument housing is made becomes important in determining the response of the instrument to the electrical properties of the Earth's formations surrounding the wellbore.

Many electromagnetic induction well logging instruments are adapted to be lowered into the wellbore and removed therefrom by means of an armored electrical cable coupled to the instrument housing. This type of instrument is known as a “wireline” instrument. Typically, the portion of the instrument housing that includes the transmitter and receiver antennas is made from electrically non-conductive, and non-magnetic material to avoid impairing the response of the well logging instrument to the earth formations surrounding the wellbore.

It is also known in the art to convey well logging instruments into the wellbore as part of a drilling tool assembly (“drill string”). Such “measurement while drilling” (MWD) logging instruments include various forms of electromagnetic induction logging instruments. As a practical matter, MWD logging instruments have steel or other high strength, metallic housings so that the instrument housing can also properly perform the function of a part of the drill string. As a result, the housings of typical MWD well logging instruments are nearly always electrically conductive. See, for example, U.S. Pat. No. 5,757,186 issued to Taicher et al. and U.S. Pat. No. ______ and U.S. Pat. No. 5,144,245 issued to Wisler. The circuits used in such MWD instruments, and the type of electrical properties measured using such instruments are determined, to a substantial degree, by the presence of the conductive drill collar in such instruments.

It is also known in the art to include high strength, electrically conductive support rods inside wireline electromagnetic induction well logging instrument in order to enable such instruments to support the weight of additional well logging instruments coupled below the induction logging instrument. See, for example, U.S. Pat. No. 4,651,101 issued to Barber et al.

It is well known in the art to include a magnetically permeable material, such as ferrite, inside the coil or loop of wire forming a magnetic dipole induction antenna for the purpose of increasing the dipole moment of such antennas with respect to the selected loop or coil size and configuration. See the previously cited Taicher et al. '186 patent, for example.

It is also known in the art to measure transient electromagnetic characteristics of Earth's formations surrounding a wellbore using a particular type of electromagnetic induction logging instrument. For example, U.S. Pat. No. 5,955,884 issued to Payton et al. discloses an instrument having at transmitter antenna coupled to a source of AC, and electromagnetic and dipole electric receiver antennas disposed on the instrument at locations spaced apart from the transmitter antenna. The AC source has a waveform adapted to induce transient electromagnetic induction effects in the earth formations surrounding the wellbore. The induction receiver and dipole electric receiver antennas detect voltages that are related to transient electromagnetic properties of the formations. It has been impracticable to provide instruments such as disclosed in the Payton et al. '884 patent with a larger electrically conductive housing because conductive housings can reduce the antenna sensitivity to the point where it is difficult to detect sufficient induction signal. Therefore, it has proven impractical for such instruments to be part of the drill string, such as in an MWD well logging instrument.

### SUMMARY OF THE INVENTION

One aspect of the invention is an electromagnetic induction logging instrument which includes an electrically conductive support. At least one magnetic dipole transmitter antenna is disposed at a selected position on the support. At least one magnetic dipole receiver antenna is disposed at a selected position on the support and is axially spaced apart from the position of the transmitter antenna. The instrument includes a magnetically permeable shield disposed between the support and the transmitter and receiver antennas. The shield extends substantially the entire distance between the transmitter and receiver antennas.

Another aspect of the invention is a measurement while drilling instrument. An instrument according to this aspect of the invention includes an electrically conductive drill collar adapted to be coupled within a drill string. At least one magnetic dipole transmitter antenna is disposed at a selected position on the drill collar. At least one magnetic dipole receiver antenna is disposed at a selected position on the drill collar, and is axially spaced apart from the position of the transmitter antenna. A magnetically permeable shield is disposed between the collar, and the transmitter and receiver antennas. The shield extends substantially the entire distance between the transmitter and receiver antennas. The instrument further includes circuits operatively coupled to the at least one transmitter antenna for passing an alternating current having a selected waveform through the at least one transmitter antenna, and includes circuits operatively coupled to the at least one receiver antenna for detecting voltages induced in the at least one receiver antenna.

Another aspect of the invention is an electromagnetic induction logging instrument. An instrument according to this aspect of the invention includes a plurality of coupled, spaced apart electrically conductive supports. At least one magnetic dipole transmitter antenna is disposed at a selected position on one of the supports. At least one magnetic dipole receiver antenna disposed at a selected position on one of the supports and is axially spaced apart from the position of the transmitter antenna. The instrument includes a magnetically permeable shield disposed on an exterior surface of each of the supports. One of the shields is disposed between the transmitter antenna and the one of the supports on which the transmitter is disposed. The same or another one of the shields is disposed between the receiver antenna and the one of the supports on which the receiver antenna is disposed. The shields extend over substantially the entire exterior of each of the supports.

Other aspects and advantages of the invention will be apparent from the following description and the appended claims.

### BRIEF DESCRIPTION OF THE DRAWINGS

FIG. 1 shows a system for drilling a wellbore which includes an example embodiment of a well logging instrument according to the invention.

FIG. 1A shows an electromagnetic measurement while drilling well logging instrument in more detail.

FIG. 2 shows a cross sectional view of one embodiment of an antenna arrangement in a well logging instrument according to the invention,

FIG. 2A shows an alternative antenna an arrangement.

FIG. 2B shows an alternative support arrangement.

FIG. 3 shows an embodiment of an axial magnetic dipole antenna.

FIG. 4 shows an embodiment of a transverse magnetic dipole antenna.

FIG. 4A shows an embodiment of an oblique magnetic dipole antenna.

FIG. 5 shows expected changes in sensitivity of an antenna system including ferrite according to one embodiment of the invention.

FIG. 6 shows expected shielding of an antenna system from effects of a conductive support using ferrite according to one embodiment of the invention.

### DETAILED DESCRIPTION

In its most general terms, the invention provides a structure for electromagnetic induction well logging instruments having an electrically conductive support structure. The electrically conductive Support structure is disposed within electromagnetic antennas used to energize earth formations and detect various electromagnetic phenomena from the formations surrounding a wellbore. The electrically conductive support structure makes it practical to include such electromagnetic instruments within a drill-collar or within an extended well logging instrument string.

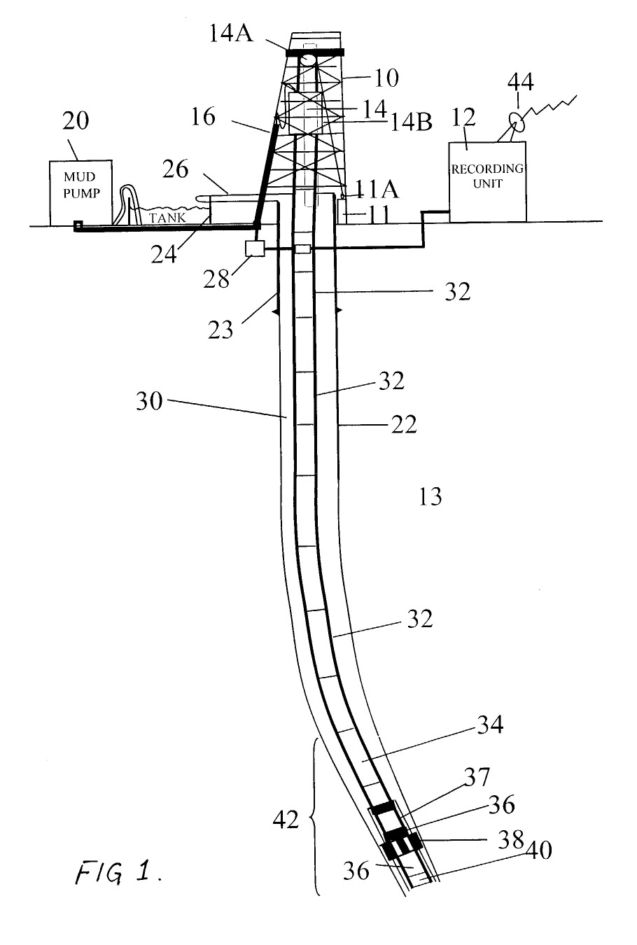

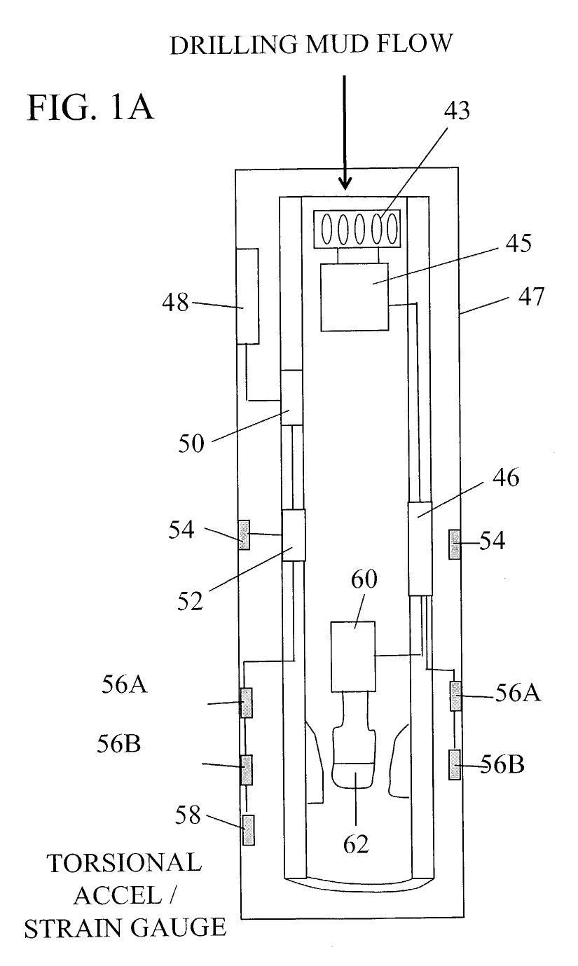

FIG. 1 shows a typical wellbore drilling system which may be used with various embodiments of a well logging instrument according to the invention. This embodiment of the invention is explained within the context of measurement while drilling systems because such systems typically require that the well logging instruments included in them be disposed in or about steel or other metallic, high strength, but electrically conductive drill collar structures.

In FIG. 1, a drilling rig 10 includes a drawworks 11 or similar lifting device known in the art to raise, suspend and lower a drill string. The drill string includes a number of threadedly coupled sections of drill pipe, shown generally at 32. A lowermost part of the drill string is known as a bottom hole assembly (“BHA”) 42, which includes, in the embodiment of FIG. 1, a drill bit 40 to cut through earth formations 13 below the earth's surface. The BHA 42 may include various devices such as heavy weight drill pipe 34, and drill collars 36. The BHA 42 may also include one or more stabilizers 38 that include blades thereon adapted to keep the BHA 42 roughly in the center of the wellbore 22 during drilling. In various embodiments, one or more of the drill collars 36 may include a measurement while drilling (“MWD”) sensor and telemetry unit (collectively “MWD system”), shown generally at 37. The sensors included in the MWD system 37 will be further explained below with reference to FIG. 1A.

The drawworks 11 is operated during active drilling so as to apply a selected axial force to the drill bit 40. Such axial force, as is known in the art, results from the weight of the drill string, a large portion of which is suspended by the drawworks 11. The unsuspended portion of the weight of the drill string is transferred to the bit 40 as axial force. The bit 40 may be rotated by turning the pipe 32 using a rotary table/kelly bushing (not shown in FIG. 1), or preferably may be rotated by a top drive 14 (or power swivel) of any type well known in the art. While the pipe 32 (and consequently the BHA 42 and bit 40) as well is turned, a pump 20 lifts drilling fluid (“mud”) 18 from a pit or tank 24 and moves it through a stand pipe/hose assembly 16 to the top drive 14 so that the mud 18 is forced through the interior of the pipe segments 32 and then the BHA 42. Ultimately, the mud 18 is discharged through nozzles or water courses (not shown) in the bit 40, where it lifts drill cuttings (not shown) to the earth's surface through an annular space between the wall of the wellbore 22 and the exterior of the pipe 32 and the BHA 42. The mud 18 then flows up through a surface casing 23 to a wellhead and/or return line 26. After removing drill cuttings using screening devices (not shown in FIG. 1), the mud 18 is returned to the tank 24.

The standpipe system 16 includes a pressure transducer 28 which generates an electrical or other type of signal corresponding to the mud pressure in the standpipe 16. The pressure transducer 28 is operatively connected to systems (not shown separately in FIG. 1) inside a recording unit 12 for decoding, recording and interpreting signals communicated from the MWD system 37. As is known in the art, the MWD system 37 includes a device, which will be explained below with reference to FIG. 1A, for modulating the pressure of the mud 18 to communicate data to the earth's surface. In some embodiments the recording unit 12 includes a remote communication device 44 such as a satellite transceiver or radio transceiver, for communicating data received from the MWD system 37 (and other sensors at the earth's surface) to a remote location. Such remote communication devices are well known in the art. The data detection and recording elements shown in FIG. 1, including the pressure transducer 28 and recording unit 12 are only examples of data receiving and recording systems which may be used with the invention, and accordingly, are not intended to limit the scope of the invention. The top drive 14 may also include a sensor, shown generally at 14B, for measuring rotational speed of the drill string, and the torque applied to the drill string. The signals from these sensors 14B may be communicated to the recording unit 12 for processing. A sensor for measuring axial load supported by the top drive 14 is shown at 14A, and is referred to as a “weight on bit” sensor or “hookload” sensor.

One embodiment of an MWD system, such as shown generally at 37 in FIG. 1, is shown in more detail in FIG. 1A. The MWD system 37 is typically disposed inside a housing 47 made from a non-ferromagnetic, electrically conductive, metallic, high strength material, for example monel or the like. The housing 47 is adapted to be coupled within the drill string at its axial ends. The housing 47 is typically configured to behave mechanically in a manner similar to other drill collars (36 in FIG. 1). The housing 47 includes disposed therein a turbine 43 which converts some of the flow of mud (18 in FIG. 1) into rotational energy to drive an alternator 45 or generator to power various electrical circuits and sensors in the MWD system 37. Other types of MWD systems may include batteries as an electrical power source.

Control over the various functions of the MWD system 37 may be performed by a central processor 46. The processor 46 may also include circuits for recording signals generated by the various sensors in the MWD system 37. In this embodiment, the MWD system 37 includes a directional sensor 50, having therein tri-axial magnetometers and accelerometers such that the orientation of the MWD system 37 with respect to magnetic north and with respect to the direction of the earth's gravity can be determined. The MWD system 37 may also include a gamma-ray detector 48 and separate rotational (angular)/axial accelerometers or strain gauges, shown generally at 58. The MWD system 37 includes an electromagnetic induction sensor system, including an AC signal generator/receiver cicuits 52, and transmitter antenna 54 and receiver 56A, 56B antennas. The induction sensor system can be of any type well known in the art for measuring electrical properties of the formations (13 in FIG. 1) surrounding the wellbore (22 in FIG. 1). One example of an electromagnetic induction sensor system is shown in U.S. Pat. No. ______ and U.S. Pat. No. 5,144,245 issued to Wisler. The system shown in the Wisler '245 patent explores the earth formations with a substantially continuous wave signal at about 2 MHz frequency. A phase and amplitude difference between signals detected at each of the two receiver antennas 56A, 56B is measured and is related to the electrical conductivity of the earth formations (13 in FIG. 1). Another type of electromagnetic induction sensor system is disclosed in U.S. Pat. No. 5,955,884 issued to Payton et al. and, for example in Published U.S. Patent Application No. 20030038634 filed by Strack. The system disclosed in the Payton et al. '884 patent includes a transient electromagnetic signal generator, such as a square wave or triangle wave generator, which when passed through the transmitter antenna 54 induces transient electromagnetic effects in the formations (13 in FIG. 1). Voltages induced in the receiver antennas 56A, 56B may be detected by circuits in the transmitter/receiver system 52 and used to infer certain electrical properties of the formations (13 in FIG. 1). Generally, an induction well logging instrument according to the invention only requires one transmitter antenna, such as shown at 54 in FIG. 1A, and one receiver antenna, such as shown at 56B in FIG. 1A. Other embodiments of an instrument according to the invention may use different numbers of and different types of electromagnetic induction antennas, and may measure different signals corresponding to different electrical properties of the earth formations. Accordingly, the embodiment of antennas and circuits shown in FIG. 1A is not intended to limit the scope of the invention.

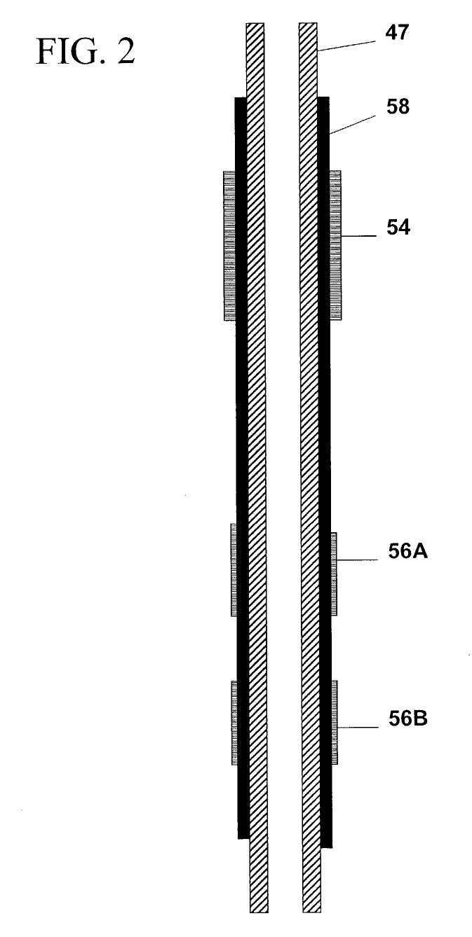

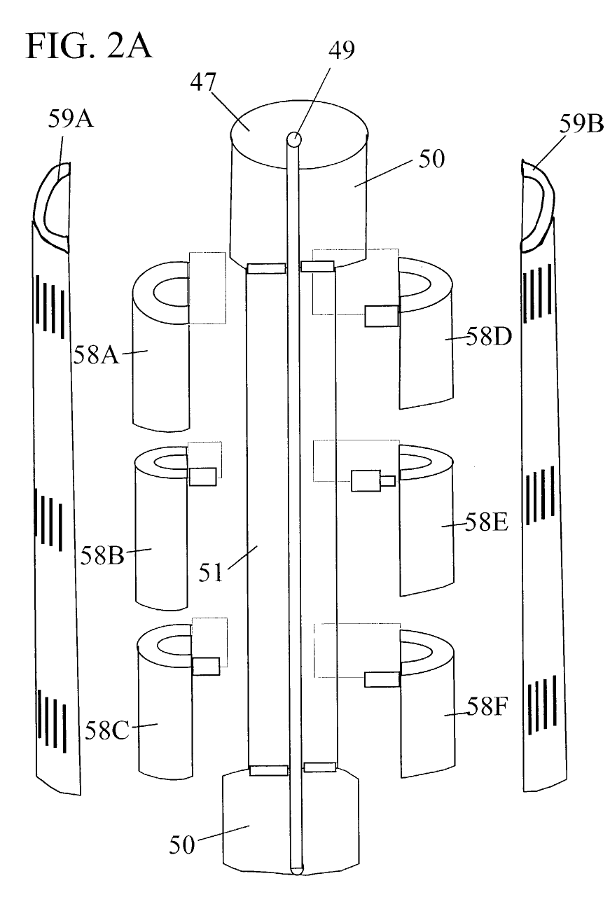

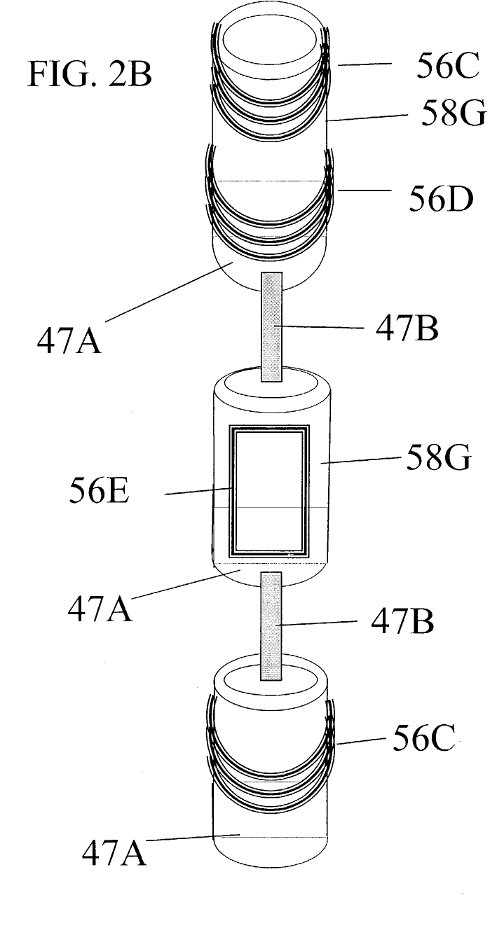

The types of sensors in the MWD system 37 shown in FIG. 2 is also not meant to be an exhaustive representation of the types of sensors used in MWD systems according to various aspects of the invention. Accordingly, the particular sensors shown in FIG. 1A (other than the electromagnetic sensor system) are not in any way meant to limit the scope of the invention.

The central processor 46 periodically interrogates each of the sensors in the MWD system 37 and may store the interrogated signals from each sensor in a memory or other storage device associated with the processor 46. Some of the sensor signals may be formatted for transmission to the earth's surface in a mud pressure modulation telemetry scheme. In the embodiment of FIG. 1A, the mud pressure is modulated by operating an hydraulic cylinder 60 to extend a pulser valve 62 to create a restriction to the flow of mud through the housing 47. The restriction in mud flow increases the mud pressure, which is detected by the transducer (28 in FIG. 1). Operation of the cylinder 60 is typically controlled by the processor 46 such that the selected data to be communicated to the earth's surface are encoded in a series of pressure pulses detected by the transducer (28 in FIG. 1) at the surface. Many different data encoding schemes using a mud pressure modulator, such as shown in FIG. 1A, are well known in the art. Accordingly, the type of telemetry encoding is not intended to limit the scope of the invention. Other mud pressure modulation techniques which may also be used with the invention include so-called “negative pulse” telemetry, wherein a valve is operated to momentarily vent some of the mud from within the MWD system to the annular space between the housing and the wellbore. Such venting momentarily decreases pressure in the standpipe (16 in FIG. 1). Other mud pressure telemetry includes a so-called “mud siren”, in which a rotary valve disposed in the MWD housing 47 creates standing pressure waves in the mud, which may be modulated using such techniques as phase shift keying for detection at the earth's surface. Other electromagnetic, hard wired (electrical conductor), or optical fiber or hybrid telemetry systems may be used as alternatives to mud pulse telemetry, as will be further explained below.

The well logging instrument shown in FIGS. 1 and 1A, as previously explained, is included in a drill collar forming part of the BHA (37 in FIG. 1). As is known in the art, various components of the BHA 37 are typically formed from high strength, electrically conductive materials, such as steel or monel. Monel is preferred in some embodiments because it is not ferromagnetic, and makes possible the use of magnetometers therein for determining orientation of the instrument with respect to the Earth's magnetic field. FIG. 2 shows the example well logging instrument of FIGS. 1 and 1A in more detail with respect to the structure of antennas disposed on the instrument and a shield intended to reduce the effects of the electrically conductive housing 47.

Generally, the well logging instrument includes a conductive metal support in the center. In FIG. 2, as in the case of typical MWD embodiments of an instrument according to the invention, the support is the housing (or mandrel), shown at 47. It should be noted that in so-called “wireline” embodiments of an instrument according to the invention, the support may be in the form of a rod or pole, such as disclosed in U.S. Pat. No. 4,651,101 issued to Barber et al.

For clarity of the illustration, various electronic circuit elements used in a typical electromagnetic induction instrument are omitted from FIG. 2. As previously explained, the housing 47 is formed from steel or other high strength material which is electrically conductive. One preferred composition of material for the housing is a non-ferromagnetic magnetic steel allow known as monel. Disposed generally about the exterior of the housing 47 is a ferromagnetic shield 58, generally formed in the shape of a tube. Ferrite is used in the present embodiment of the shield 58, although in other embodiments, the material may be any type which has magnetic permeability on the order of that of ferrite, and has electrical conductivity similar to ferrite materials known in the art. In some embodiments the resistivity of the material used to form the shield 58 is preferably at least about 1 ohm-m.

The ferromagnetic shield 58 in the present embodiment extends over the length of the housing for substantially the entire axial distance between a transmitter antenna 54 and a more distant one 56B of a pair of receiver antennas, shown generally at 56A, 56B. In the embodiment shown in FIG. 2 the shield 58 forms a substantially continuous tube, however, it has been determined that a plurality of smaller length tubes disposed on the exterior of the mandrel will perform substantially as well as the continuous tube shown in FIG. 2, provided that a gap between successive shield cylinders is not more than about 1 centimeter (cm). In the embodiment shown in FIG. 2, a wall thickness of the shield 58 is about 7 millimeters (mm). It is believed that the benefits of the shield according to the invention will be obtained with shield wall thickness of as small as about 3 mm.

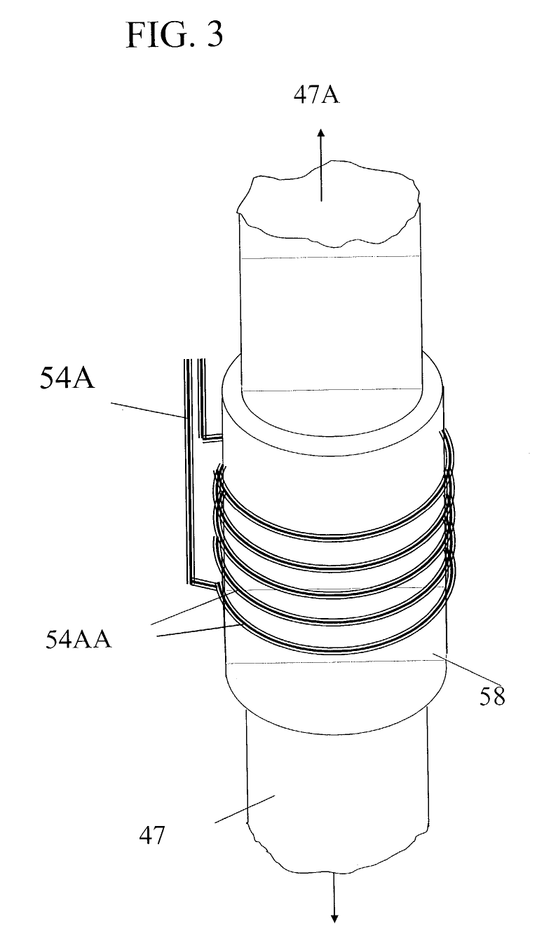

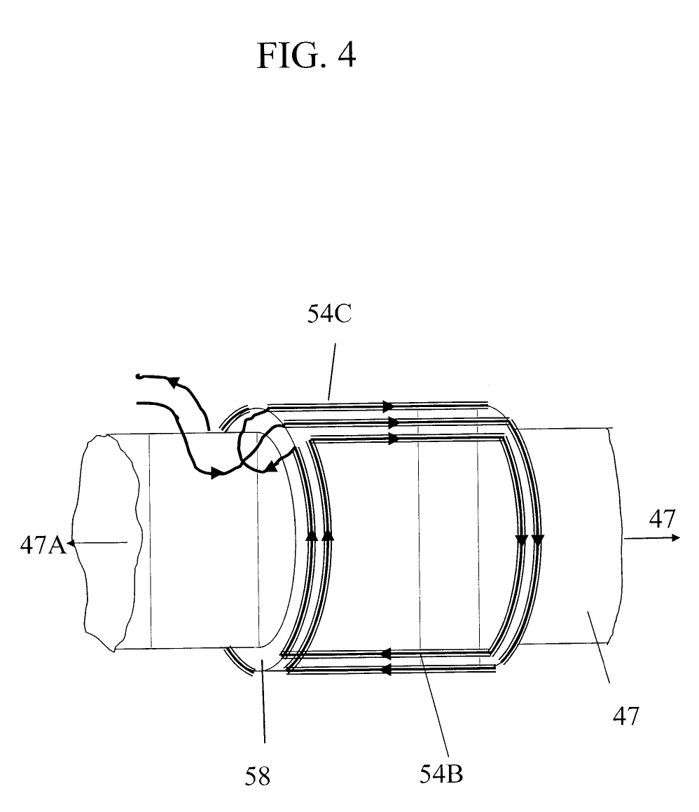

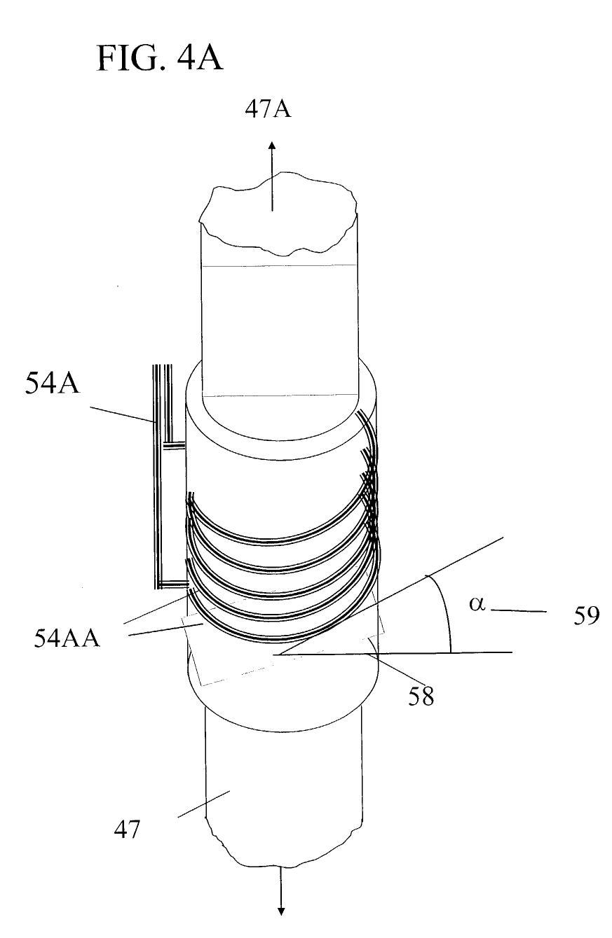

An example embodiment of a housing and shield structure that is suitable for measurement while drilling operations is shown in FIG. 2A. The housing 47 includes a central bore 49 for passage of drilling fluid as previously explained with respect to FIG. 1. At the axial ends of the housing 47, the housing diameter is substantially that of a “standard” drill collar, as shown generally at 50, and referred to as the full diameter part of the housing 47. A reduced outer diameter section on the housing 47, as shown generally at 51, forms a base for mounting antennas of structures such as will be explained below with respect to FIGS. 3 and 4. The shield (58 in FIG. 1a) in this embodiment is formed from a plurality of substantially cylindrical half-sections, shown at 58A through 58F, which are affixed or otherwise coupled to the outer surface of the reduced outer diameter section 51 of the housing 47. When affixed to the reduced diameter section 51, the half sections 58A-58F form the equivalent of a substantially cylindrical shield that extends over the length of the reduced diameter section 51 of the housing 47. The antennas (not shown in FIG. 2A) will be affixed to the outer surface of the assembled shield half-sections 58A through 58F, at axial positions selected with respect to the particular attributes of the electromagnetic measurements to be made with the particular logging instrument. Protective cover sections at 59A and 59B may be coupled or affixed to housing 47 so as to cover the exterior of the antennas (not shown in FIG. 2A), to protect the antennas from abrasion and damage during movement of the housing 47 through the wellbore. The cover sections 59A, 59B may be made from steel, monel, fiberglass or other material known in the art for protecting antennas on measurement while drilling instruments. Preferably, the outside diameter of the assembled shield half-sections 58A-58F, antennas (not shown) and cover sections 59A, 59B is at most equal to the full diameter of the housing, as shown at 50.

One embodiment of antenna that may be used with various embodiments of a well logging instrument according to the invention is shown in more detail in FIG. 3. The antenna 54A shown in FIG. 3 is known in the art as an axial magnetic dipole, and is formed as a plurality of coils 54AA wound so that they lie in planes substantially perpendicular to the longitudinal axis 47A of the housing 47. Generally, the dipole moment of the antenna 54A in FIG. 3 is parallel to the axis 47A of the housing 47. The antenna 54A in FIG. 3 may be used for any one or more of the transmitter and receivers in any embodiment of a well logging instrument according to the invention.

An alternative embodiment of antenna that may be used in various embodiments of a well logging instrument according to the invention is shown in FIG. 4. The antenna forms, shown generally at 54B and 54C are known in the art as saddle coils, and each forms an axial magnetic dipole having magnetic dipole moment substantially perpendicular to the axis 47A of the housing 47. Another alternative embodiment includes antennas having magnetic dipole axes at oblique or “tilted” angles with respect to the axis 47A of the housing 47. Examples of tilted coils are described in Sato, U.S. Pat. No. 5,508,616. A schematic of a tilted or oblique coil is shown in FIG. 4A. The coil is constructed similar to the one in FIG. 3 except that the windings are tilted on the housing 47 with respect to the axis 47A. The tilt angle α, is shown at 59 in FIG. 4A. Other embodiments wherein the shield 58 is also tilted are possible.

Irrespective of the type and number of transmitter and receiver antennas on a logging instrument, it is only necessary in any embodiment of a well logging instrument according to the invention that the shield 58 extend substantially the entire span between the most distantly spaced apart of the transmitter and receiver antennas. It has been determined that the effectiveness of the shield 58 with respect to the conductive nature of the housing 47 is enhanced when the shield 58 traverses the entire length as described.

The foregoing embodiments have been described with respect to a single conductive support for the transmitter and receiver antennas. Other embodiments may include more than one such conductive support interconnected, for example, by flexible, reinforced electrical cable segments. One such multiple conductive support, for example, is shown in Published U.S. Patent Application No. 20030038634 filed by Strack. In embodiments having more than one conductive support, the shield (58 in FIG. 1A) need only cover substantially all of the conductive supports in order to be effective. The interconnecting cables need not be covered. An example embodiment of a well logging instrument including a plurality of electrically conductive supports is shown in FIG. 2B. The supports 47A are generally shaped as cylinders, and as in the previously described embodiments may be made from steel, monel or other electrically conductive material. The supports 47A are interconnected by segments 47B of reinforced electrical cable of types well known in the art. Antennas of various forms, shown at 56C and 56D as axial magnetic dipoles, and at 56E as a transverse magnetic dipole. Some supports 47A may not have any antennas on them, and other supports may have two or more such antennas. Accordingly, the exact arrangement of transmitter and receiver antennas with respect to any one of the supports 47A is not intended to limit the scope of the invention. Each of the supports 47A is covered about its exterior surface by a shield 58G formed from ferrite or similar magnetically permeable material. Wall thickness and configuration of the shield 58G in the present embodiment can be similar to that in the previously described embodiments.

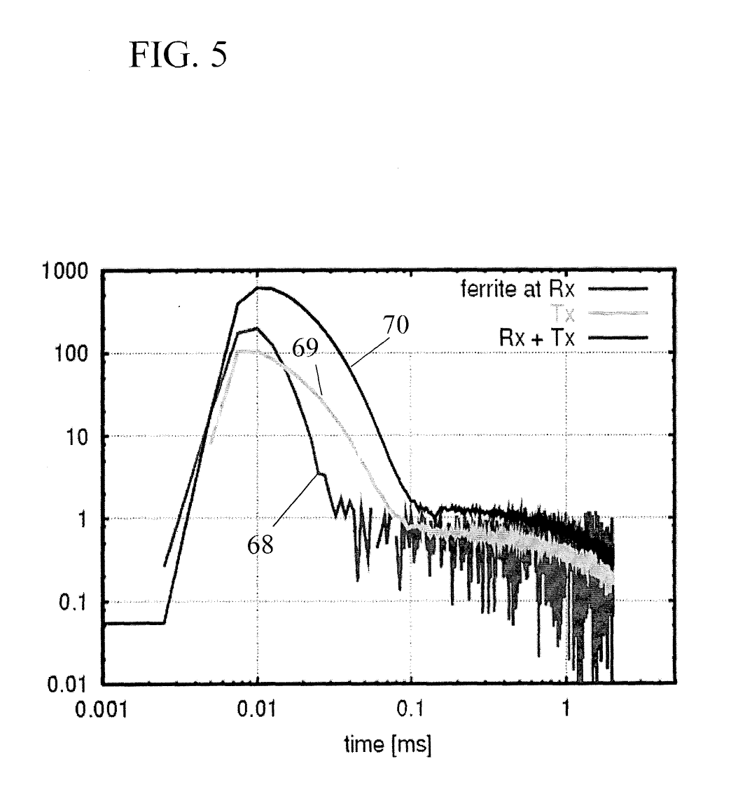

FIG. 5 shows a graph of results of experiments made with an experimental apparatus. The experimental apparatus includes a single axial magnetic dipole transmitter antenna, and a single axial magnetic dipole receiver antenna disposed on a conductive steel mandrel at a selected distance from the transmitter antenna. The transmitter antenna was energized using an AC signal. The signal current was a sequence of alternate positive and negative rectangular shaped pulses with 50 msec length, with 2 ampere amplitude and a repetition period of 250 msec. Voltages induced in the receiver coil were measured. The three curves 68, 69 and 70 show electromagnetic transients measured with a tubular ferrite layer disposed only below the receiver antenna (curve Rx or 68), disposed only below the transmitter antenna (curve Tx or 69) and disposed substantially the entire span between the transmitter and receiver antennas (curve Rx+Tx or 70). The increase of receiver voltage amplitudes using a shield (58 in FIG. 2) disposed over the entire transmitter/receiver span, as compared to those measured using ferrite shields only under the transmitter or receiver show the enhancement effect of the shield 58 according to the invention. The amplification effect of the signal is visible by comparing curve 70 with 68 and 69. The signal of 70 is after 0.05 seconds larger than 68 and 69 which is caused by the ferrite. Since 70 is at these times principally parallel shifted compared to 68 and 69 on the logarithmic display, the increase is mainly an amplification factor.

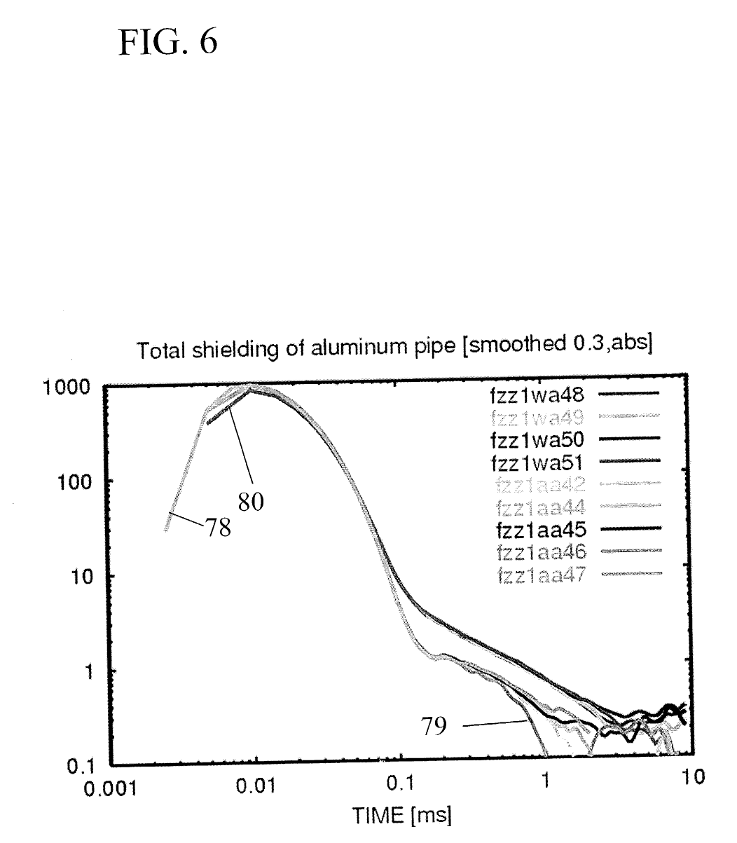

FIG. 6 shows a graph of induced transient voltages measured with the experimental apparatus referred to with respect to FIG. 5. The measurements were made first in a substantially non-conductive environment (air or for example 78 or 79) and then in a conductive environment (in water having an electrical conductivity of about 1 ohm-m or for example 80). All transient voltages measured in water and air were averaged, and the averaged and smoothed results (5 transient measurement sets in air and 4 transient measurement sets in water) are shown in the graph of FIG. 6. Theory and model (simulated response) calculations show that in the presence of a conductive housing (47 in FIG. 2) and no shield (58 in FIG. 2) the differences in measured transient response between the resistive and conductive environments would be much smaller than the housing effects, and therefore these differences would not be clearly visible. As can be observed in FIG. 6, however, the differences between electromagnetic transient measurements made in air and those made in water using the shield (58 in FIG. 2) according to the invention are clearly visible. In the time range 0.1 to 3 milliseconds, the receiver voltage amplitudes measured in water (at about 1 ohm-m conductivity) are about two times higher than those measured in air. This is caused by the secondary current that flow in the conductive water compared to little or no currents flowing in the resistive air.

Well logging apparatus according to the invention provide, in some embodiments, a means for making electromagnetic transient induced voltage measurements where antennas are disposed on a conductive sonde support. Such embodiments have particular application in measurement while drilling instrument systems where the instrument components must be disposed in a conductive, metallic drill collar.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An electromagnetic induction logging instrument, comprising:
an electrically conductive support;
at least one magnetic dipole transmitter antenna disposed at a selected position on the support;
at least one magnetic dipole receiver antenna disposed at a selected position on the support axially spaced apart from the position of the transmitter antenna; and
a magnetically permeable shield disposed between the support and the transmitter and receiver antennas, the shield extending substantially the entire distance between the transmitter and receiver antennas.

2. The instrument of claim 1 wherein the shield comprises ferrite.

3. The instrument of claim 1 wherein the shield comprises a tube.

4. The instrument of claim 1 wherein the shield comprises a plurality of tubes disposed end to end on the support, a gap between any two of the tubes at most about 1 centimeter.

5. The instrument of claim 1 wherein at least one of the transmitter and receiver antennas comprises an axial magnetic dipole antenna.

6. The instrument of claim 1 wherein at least one of the transmitter and receiver antennas comprises a transverse magnetic dipole antenna.

7. The instrument of claim 1 wherein at least one of the transmitter and receiver antennas comprises an oblique magnetic dipole antenna.

8. The instrument of claim 1 wherein the shield has a wall thickness of about 3 to 7 millimeters.

9. The instrument of claim 1 wherein the support comprises a drill collar.

10. The instrument of claim 1 wherein the support comprises monel.

11. The instrument of claim 1 further comprising circuits for energizing the at least one transmitter antenna with a continuous wave signal.

12. The instrument of claim 1 further comprising circuits for energizing the at least one transmitter antenna with a time domain signal.

13. The instrument of claim 1 further comprising circuits for detecting continuous wave electromagnetically induced voltages operatively coupled to the at least one receiver antenna.

14. The instrument of claim 1 further comprising circuits for detecting time domain electromagnetically induced voltages operatively coupled to the at least one receiver antenna.

15. The instrument of claim 1 wherein the shield comprises a material having an electrical resistivity of at least about one ohm meter.

16. A measurement while drilling instrument, comprising:
an electrically conductive drill collar adapted to be coupled within a drill string;
at least one magnetic dipole transmitter antenna disposed at a selected position on the drill collar;
at least one magnetic dipole receiver antenna disposed at a selected position on the drill collar axially spaced apart from the position of the transmitter antenna;
a magnetically permeable shield disposed between the drill collar and the transmitter and receiver antennas, the shield extending substantially the entire distance between the transmitter and receiver antennas;
circuits operatively coupled to the at least one transmitter antenna for passing an alternating current having a selected waveform through the at least one transmitter antenna; and
circuits operatively coupled to the at least one receiver antenna for detecting voltages induced in the at least one receiver antenna.

17. The instrument of claim 16 further comprising means for recording signals corresponding to the detected voltages.

18. The instrument of claim 16 further comprising means for communicating signals to equipment at the Earth's surface from within a wellbore.

19. The instrument of claim 18 wherein the means for communicating comprises a mud pressure modulation telemetry valve and control circuits operatively coupled thereto.

20. The instrument of claim 16 wherein the shield comprises ferrite.

21. The instrument of claim 20 wherein an electrical resistivity of the ferrite is at least about 1 ohm-m.

22. The instrument of claim 16 wherein the shield comprises a tube.

23. The instrument of claim 16 wherein the shield comprises a plurality of tubes disposed end to end on the support, a gap between any two of the tubes at most about 1 centimeter.

24. The instrument of claim 16 wherein at least one of the transmitter and receiver antennas comprises an axial magnetic dipole antenna.

25. The instrument of claim 16 wherein at least one of the transmitter and receiver antennas comprises a transverse magnetic dipole antenna.

26. The instrument of claim 16 wherein at least one of the transmitter and receiver antennas comprises an oblique magnetic dipole antenna.

27. The instrument of claim 16 wherein the shield has a wall thickness of about 3 to 7 millimeters.

28. The instrument of claim 16 wherein the circuits comprise means for energizing the at least one transmitter antenna with a continuous wave signal.

29. The instrument of claim 16 wherein the circuits comprise means for energizing the at least one transmitter antenna with a time domain signal.

30. The instrument of claim 16 further wherein the circuits comprise means for detecting continuous wave electromagnetically induced voltages operatively coupled to the at least one receiver antenna.

31. The instrument of claim 16 wherein the circuits comprise means for detecting time domain electromagnetically induced voltages operatively coupled to the at least one receiver antenna.

32. The instrument of claim 16 wherein the drill collar comprises monel.

33. The instrument of claim 16 wherein the shield comprises a material having an electrical resistivity of at least about one ohm meter.

34. An electromagnetic induction logging instrument, comprising:
a plurality of coupled, spaced apart electrically conductive supports;
at least one magnetic dipole transmitter antenna disposed at a selected position on one of the supports;
at least one magnetic dipole receiver antenna disposed at a selected position on one of the supports and axially spaced apart from the position of the transmitter antenna; and
a magnetically permeable shield disposed on an exterior surface of each of the supports, one of the shields disposed between the transmitter antenna and the one of the supports on which the transmitter is disposed, one of the shields disposed between the receiver antenna and the one of the supports on which the receiver antenna is disposed, the shields extending over substantially the entire exterior of each of the supports.

35. The instrument of claim 34 wherein the shields comprise ferrite.

36. The instrument of claim 34 wherein the shields comprise tubes.

37. The instrument of claim 34 wherein the shields comprise a plurality of tubes disposed end to end on each support, a gap between any two of the tubes at most about 1 centimeter.

38. The instrument of claim 34 wherein at least one of the transmitter and receiver antennas comprises an axial magnetic dipole antenna.

39. The instrument of claim 34 wherein at least one of the transmitter and receiver antennas comprises a transverse magnetic dipole antenna.

40. The instrument of claim 34 wherein at least one of the transmitter and receiver antennas comprises an oblique magnetic dipole antenna.

41. The instrument of claim 34 wherein the shields have a wall thickness of about 3 to 7 millimeters.

42. The instrument of claim 34 wherein the support comprises monel.

43. The instrument of claim 34 further comprising circuits for energizing the at least one transmitter antenna with a continuous wave signal.

44. The instrument of claim 34 further comprising circuits for energizing the at least one transmitter antenna with a time domain signal.

45. The instrument of claim 34 further comprising circuits for detecting continuous wave electromagnetically induced voltages operatively coupled to the at least one receiver antenna.

46. The instrument of claim 34 further comprising circuits for detecting time domain electromagnetically induced voltages operatively coupled to the at least one receiver antenna.

47. The instrument of claim 34 wherein the shields comprise a material having an electrical resistivity of at least about one ohm meter.
